(19) United States
(12) Patent Application Publication
(10) Pub. No.: US 2026/0220218 A1
(43) Pub. Date: Jul. 30, 2026

(54) NON-TRANSITORY COMPUTER-READABLE STORAGE MEDIUM STORING SUPPORT PROGRAM

(71) Applicant: BROTHER KOGYO KABUSHIKI KAISHA, Nagoya (JP)

(72) Inventors: Airi EGUCHI, Ichinomiya (JP); Kenju NARITA, Nagoya (JP); Tatsuhiko SONE, Nagoya (JP)

(21) Appl. No.: 19/578,267

(22) Filed: Mar. 25, 2026

Related U.S. Application Data
(63) Continuation-in-part of application No. 19/304,820, filed on Aug. 20, 2025.
Application No. 19/304,820 is a continuation of application No. PCT/JP2024/005601, filed on Feb. 16, 2024.

(30) Foreign Application Priority Data
Feb. 21, 2023 (JP) 2023-025147
May 14, 2025 (JP) 2025-081429

(51) Int. Cl. G06F 16/954; G06F 3/12

(52) U.S. Cl. CPC G06F 16/954; G06F 3/1202; G06F 3/1228; G06F 3/1232; G06F 3/1253; G06F 3/1287

(57) ABSTRACT

A non-transitory computer readable storage medium storing a support program which being executable by a computer of an information processing device and operates in cooperation with a universal printing program provided in an operating system of the information processing device. The support program causes the computer to execute obtaining processing of obtaining device information including model information indicating a model of a printer associated with the support program. The support program further causes the computer to execute guide display processing of displaying a guide object for guiding to a specific web page corresponding to the model indicated by the model information included in the device information obtained in the obtaining processing, when a predetermined execution instruction is received from the operating system in a state where the printer associated with the support program is selected.

### REFERENCE TO RELATED APPLICATIONS

This is a continuation in part application of U.S. Application No. 19/304,820 filed on August 20, 2025, which is a continuation of International Application No. PCT/JP2024/005601 filed on February 16, 2024. This application claims priority from Japanese Patent Application No. 2023-025147 filed on February 21, 2023, and Japanese Patent Application No. 2025-081429 filed on May 14, 2025. The entire contents of the aforementioned applications are incorporated herein by reference.

### BACKGROUND ART

In a related art, a technique for displaying a specific web page is known. A PC disclosed in the related art receives, from a user, input of a country or a region where the printer is used. Then, data in which the country or the region is associated with a URL in advance is referred to, and a URL associated with the received country or region is obtained. Then, it is determined whether a consumption degree of consumables used in the printer satisfies a criterion obtained by a rule determined in advance. Then, if it is determined that the criterion is satisfied, a web page that is specified by the obtained URL and allows purchase of the consumables is accessed.

In recent years, there has been a technique for controlling a printer by an OS-standard printing function constituting a part of an operating system (OS). In the above technique, when detecting a printer, the OS establishes an association between the printer and an OS-standard universal printing program. In a configuration using the OS-standard universal printing program, a printer driver provided by a printer vendor is not used. When the printer and the universal printing program are associated with each other, printing through the OS-standard universal printing program is enabled when a print instruction for the printer is received.

In a configuration using the OS-standard printing function, a support program for executing processing based on an instruction from the OS can be installed along with the processing of the OS-standard printing function. Since the support program operates in cooperation with the OS, extension of the OS-standard printing function can be expected. In a configuration having such a support program, a technique capable of guiding a user to a specific web page is desired.

### SUMMARY

A non-transitory computer readable storage medium storing a support program which being executable by a computer of an information processing device and operates in cooperation with a universal printing program provided in an operating system of the information processing device, the support program causing the computer to execute obtaining processing of obtaining device information including model information indicating a model of a printer associated with the support program; and further causing the computer to execute guide display processing of displaying a guide object for guide to a specific web page corresponding to the model indicated by the model information included in the device information obtained in the obtaining processing, when a predetermined execution instruction is received from the operating system in a state where the printer associated with the support program is selected.

### BRIEF DESCRIPTION OF DRAWINGS

FIG. 1 is a block diagram showing an outline of an electrical configuration of a PC.

FIG. 2 is a diagram illustrating an example of a print setting screen.

FIG. 3 is a sequence diagram showing a procedure when a printer is selected.

FIG. 4 is a sequence diagram showing a procedure when a detailed setting button is operated.

FIG. 5 is a diagram illustrating an example of a basic setting page on a detailed setting screen.

FIG. 6 is a diagram illustrating an example of a web page.

FIG. 7 is a sequence diagram showing a procedure when a consumables information tab is operated.

FIG. 8 is a diagram illustrating an example of a consumables information page on the detailed setting screen.

FIG. 9 is a sequence diagram showing a procedure when a service information tab is operated.

FIG. 10 is a diagram illustrating an example of a service information page on the detailed setting screen.

FIG. 11 is a sequence diagram showing an example of a print execution procedure.

FIG. 12 is a diagram illustrating an application example of the consumables information page on the detailed setting screen.

### DESCRIPTION

Hereinafter, a personal computer (hereinafter, referred to as "PC") that uses a support program according to an embodiment will be described in detail with reference to the accompanying drawings. The present description discloses a support program to be executed on the PC.

### Configuration of PC

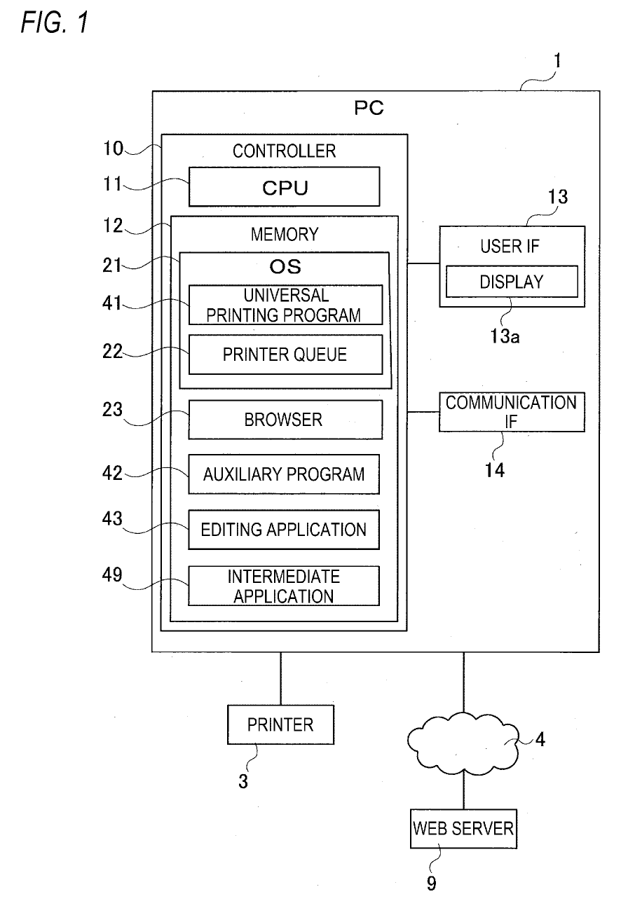

A PC 1 of the present embodiment includes a controller 10 including a CPU 11 and a memory 12, as shown in FIG. 1. The PC 1 is an example of an "information processing device". The CPU 11 is an example of a computer. Further, the PC 1 includes a user interface (hereinafter referred to as "user IF") 13 and a communication interface (hereinafter referred to as "communication IF") 14. The user IF 13 and the communication IF 14 are electrically connected to the controller 10. The controller 10 is a collective term for hardware and software used to control the PC 1, and does not necessarily represent a single piece of hardware actually existing in the PC 1.

The CPU 11 executes various types of processing in accordance with a program read from the memory 12 or based on an operation of a user. The memory 12 stores various programs and various data. The memory 12 also serves as, for example, a workspace when executing various types of programs. A buffer provided in the CPU 11 is also an example of the memory 12. The memory 12 is not limited to a ROM or the like built in the PC 1, and may be a recording medium such as a CD-ROM or a DVD-ROM readable and writable by the CPU 11.

The user IF 13 includes a display 13a, which is hardware for displaying a screen for notifying a user of information, and hardware for receiving an operation from the user. The user IF 13 may include a combination of the display 13a capable of displaying information and a mouse, a keyboard, or the like having an input receiving function. A touch panel having a function of the display 13a and the input receiving function may be included.

The communication IF 14 includes hardware for communicating with an external device. Communication standards of the communication IF 14 include Ethernet (registered trademark), Wi-Fi (registered trademark), USB, and the like. The PC 1 may be connectable to the Internet via the communication IF 14. The PC 1 may include multiple communication IFs 14 for supporting multiple communication standards.

As shown in FIG. 1, the memory 12 stores an operating system (hereinafter, referred to as OS) 21 including a universal printing program 41. Further, the memory 12 can store various programs and various types of data, including a browser 23, an auxiliary program 42, an editing application 43, and an intermediate application 49. The auxiliary program 42 is an example of a support program. In the present description, the application program may be referred to as "application".

The OS 21 is a multitasking OS that manages multiple tasks and switches between the multiple tasks, thereby handling several tasks simultaneously. The OS 21 is, for example, Windows (registered trademark), mac OS (registered trademark), Linux (registered trademark), iOS (registered trademark), or Android (registered trademark).

The OS 21 includes a universal printing program 41 and a printer queue 22. The universal printing program 41 is an OS-standard program that is developed by a vendor of the OS 21 and provided as a part of the OS 21. The universal printing program 41 is packaged together with, for example, the OS 21 and installed in the PC 1. That is, the PC 1 is equipped with the OS 21 including the universal printing program 41. Further, the OS 21 can also be said to include the OS-standard universal printing program 41. The universal printing program 41 is not configured to use a printer driver specific to each printer.

The browser 23 is a program having a function of displaying, on the user IF 13, a web page provided by a web server 9. The browser 23 may be configured as a part of the OS 21.

The universal printing program 41 has a function of causing printers of multiple models provided by multiple vendors to perform printing. The universal printing program 41 provides a universal function that allows many printers to perform printing. The universal printing program 41 can communicate with various types of printers compatible with an IPP, for example, by communication corresponding to the IPP. The IPP is an abbreviation for Internet Printing Protocol. Unlike the printer driver specific to each printer, the universal printing program 41 does not provide a function specific to each printer or printer driver. Examples of the universal printing program 41 include an IPP Class Driver provided by Microsoft Corporation.

The universal printing program 41 receives image data designated as a print target by a print instruction output from various application programs, based on a user instruction. Then, intermediate data based on the received image data is generated. The intermediate data is, for example, XPS data. The universal printing program 41 further has a function of generating, based on the intermediate data, print data in a format available for printing by various types of printers. The print data is, for example, PDF data or PWG Raster data. The universal printing program 41 further has a function of transmitting the generated print data to a printer designated as a device for performing printing, using a communication function of the OS 21.

The OS 21 can register the printer queue 22 corresponding to the printer connected to the PC 1. Since the printer queue 22 can be registered for each connected printer, the OS 21 can be provided with multiple printer queues 22. In the present embodiment, the printer 3 is connected to the PC 1, and the printer queue 22 corresponding to the printer 3 is registered.

The auxiliary program 42 is a program or a group of programs that cooperate with the universal printing program 41 to execute processing based on an instruction from the OS 21. The auxiliary program 42 is an application program that controls target hardware, for example, controls printing of a printer. The auxiliary program 42 of the present embodiment corresponds to a model of a printer, and is provided by a vendor of the printer, for example. When a predetermined printer is selected as the printer for performing printing, the universal printing program 41 activates the auxiliary program 42 associated with the predetermined printer. In a case where an instruction for detailed print setting is received in a state where a predetermined printer is selected, the auxiliary program 42 associated with the predetermined printer is also activated. In a case where an instruction for causing a predetermined printer to perform printing is received, the auxiliary program 42 associated with the predetermined printer is also activated. The auxiliary program 42 is called, for example, a print support application (abbreviated as PSA). Alternatively, the auxiliary program 42 is called a hardware support application (abbreviated as HSA).

In the present embodiment, the printer 3 and the auxiliary program 42 are associated. Specifically, information on the printer queue 22 corresponding to the printer 3 and identification information of the auxiliary program 42 are stored in the memory 12 in association with each other. Therefore, when the printer 3 is selected, the universal printing program 41 activates the auxiliary program 42.

The auxiliary program 42 may be a combination of multiple programs, or may be a single program capable of executing different types of processing according to instructions. Further, the auxiliary program may be a program prepared for each type of printer by the vendor of the printer. For example, an auxiliary program for an inkjet printer or an auxiliary program for a laser printer may be prepared. The auxiliary program may be prepared not only for each type of printer but also for each model of printer or each series of printer models.

When detecting connection of a new printer to the PC 1, the OS 21 can download and install an appropriate auxiliary program 42 according to a model of the detected printer. The OS 21 can download the auxiliary program 42 from, for example, a server of the vendor of the printer or a website designated by the OS 21. The OS 21 stores identification information of the installed auxiliary program 42 in the memory 12 in association with information on the newly connected printer. In the present description, the OS 21 detecting connection of a new printer to the PC 1 is also simply referred to as detection of a printer. A timing at which the auxiliary program 42 is installed is not limited to a timing at which the printer is detected. For example, a file for installing the auxiliary program 42 may be distributed to the PC by an administrator, and the installation may be performed from the distributed file.

The editing application 43 is, for example, a program for creating and editing image data and document data. The editing application 43 may be, for example, Word (registered trademark) or PowerPoint (registered trademark) manufactured by Microsoft (registered trademark). Further, the editing application 43 may be programs provided by vendors of various types of printers. The editing application 43 can receive, via the user IF 13, a printer selection instruction and a print execution instruction for causing the printer to perform printing, for example. The editing application 43 is not limited to a program for creating or editing data. The editing application 43 may be a program having a function of receiving instructions to display or print various types of information, such as map information or web pages, in response to a user request.

The intermediate application 49 is a Win 32 application outside a sandbox in which the auxiliary program 42 is located. The intermediate application 49 is outside the sandbox and is not restricted based on the sandbox by OS 21, and thus can mediate, for example, the auxiliary program 42 and other applications. The intermediate application 49 is used by the auxiliary program 42 as necessary.

As shown in FIG. 1, the printer 3 having a printing function is connected to the PC 1. The printer connected to the PC 1 may have a scan function, a copy function, a FAX transmission and reception function, and an e-mail transmission and reception function in addition to the printing function. In the present description, a printer having the above-described functions is also referred to as "printer". The printer 3 of the present embodiment is, for example, an IPP-compliant printer.

The PC 1 is connected, via an Internet 4, to the web server 9 that provides one or more web pages. The web server 9 shown in FIG. 1 is an example of a server that provides the web page, and is not limited to one web server. Multiple web servers 9 exist on the Internet 4, and various web pages are provided for each web server 9. Examples of the web server 9 include a server of a vendor of the printer 3 and a server of a company that provides a service using the printer 3.

### Control of PC

Next, procedures of various types of processing for causing the printer to perform printing based on instructions to the universal printing program 41 in the PC 1 of the present embodiment will be described. Each type of processing other than an operation of the user in the present embodiment basically indicates processing of the CPU 11 according to instructions described in programs such as the auxiliary program 42 and the like. In the present description, various types of processing performed by the controller 10 or the CPU 11 according to respective programs may be described such that the respective programs autonomously perform the various types of processing for convenience. The processing executed by the CPU 11 also includes control of hardware using APIs of the OS 21. In the present description, a detail description of the OS 21 is omitted, and an operation of each program is described.

Procedure of Performing Print Setting from Editing Application

First, a processing procedure for performing print setting from the editing application will be described. The editing application 43 can create or edit a sentence or an image based on a user instruction. When the user wants to print the text or image that is being displayed, printing is selected via the editing application 43. When the printing is selected, the editing application 43 displays, on the user IF 13, a print setting screen capable of receiving print settings and print instructions.

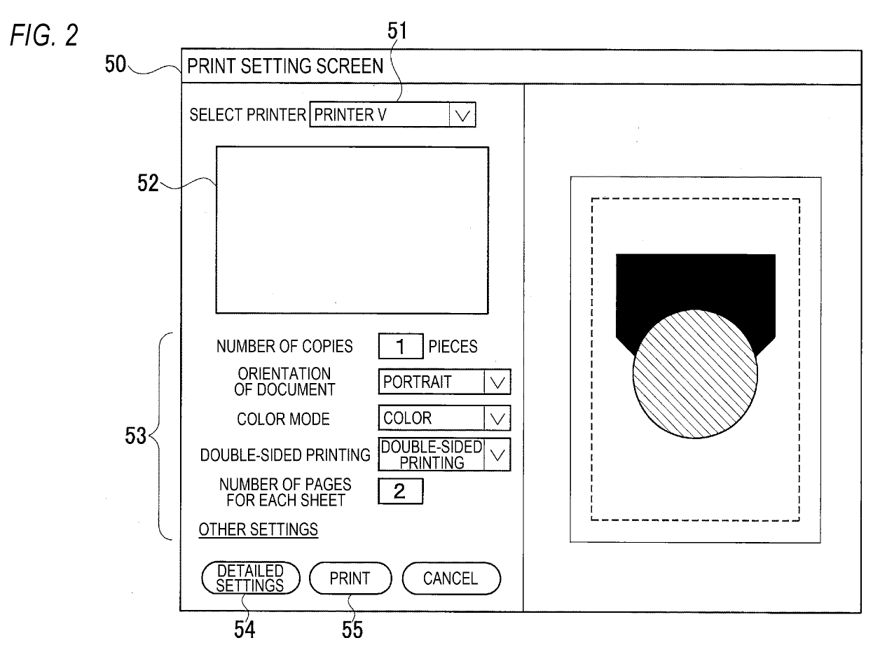

FIG. 2 shows an example of a print setting screen 50 displayed by the editing application 43. The print setting screen 50 includes a printer selection field 51, an information display field 52, a basic print setting selection field 53, a detailed setting button 54, and a print button 55. The print setting screen 50 is a screen for receiving user instructions for various print settings that can be received by the universal printing program 41. The print setting screen 50 may be displayed by the universal printing program 41 based on an instruction from the editing application 43.

The printer selection field 51 is a field for receiving selection of a printer for performing printing. The printer selection field 51 includes printers corresponding to the printer queues 22 provided in the OS 21 as options. In the present description, selecting the printer queue 22 may be referred to as selecting the printer.

The information display field 52 is a field for displaying information designated by the auxiliary program corresponding to the printer selected in the printer selection field 51. The basic print setting selection field 53 is a field for receiving basic settings such as the number of copies to be printed and an orientation of a document. The detailed setting button 54 is a button for receiving an instruction to perform detailed settings not included in the basic print setting selection field 53. The print button 55 is a button for receiving an instruction to execute printing with the selected print settings.

When the print setting screen 50 is initially displayed, the universal printing program 41 selects a printer set as a default as a printer to be displayed in the printer selection field 51. Then, print setting information indicating print settings that can be set in the printer set as the default is obtained. Then, based on the obtained print setting information, options for various items selectable in the print setting selection field 53 are determined.

### Procedure when Printer is Selected

The user can select a printer by an operation on the printer selection field 51. The selectable printer is a printer provided with a printer queue, and a display name registered in each printer queue is displayed as an option in a list in the printer selection field 51. When a printer is selected, the universal printing program 41 switches the print setting selection field 53 to contents corresponding to the selected printer.

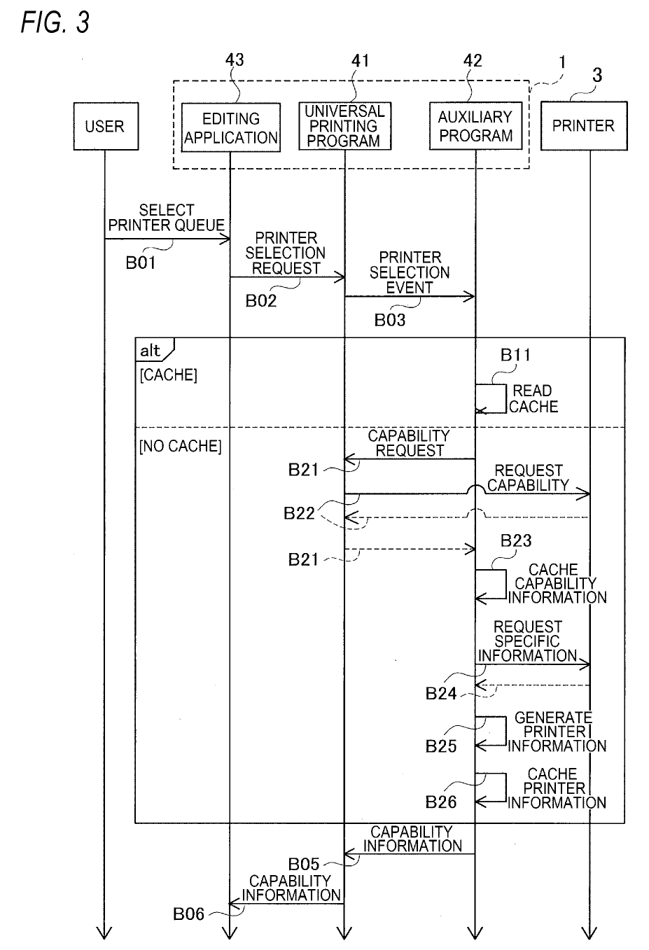

Specifically, when the printer 3 is selected by the operation on the printer selection field 51, a procedure shown in a sequence diagram of FIG. 3 is performed. First, the printer 3 is selected by operating the printer queue 22 corresponding to the printer 3 in the printer selection field 51 (B01). When the printer 3 is selected, a printer selection request specifying the selected printer 3 is transferred from the OS 21 to the universal printing program 41 (B02). The universal printing program 41 to which the printer selection request is transferred activates the auxiliary program 42 and issues a printer selection event in a state where the printer 3 is selected (B03).

The auxiliary program 42 determines whether capability information and printer information of the selected printer 3 are cached. The capability information includes, for example, compatibility of various functions, settable ranges of setting values, options, exclusive information, and default values. The printer information stores printer-specific information, such as a model name, a serial number, and a firmware version. If the capability information and the printer information are cached, the auxiliary program 42 reads the cached information (B11).

On the other hand, if at least one of the capability information and the printer information is not cached, the auxiliary program 42 executes processing necessary for caching. Specifically, the auxiliary program 42 requests the universal printing program 41 to obtain the capability information (B21). The universal printing program 41 obtains the capability information from the printer 3 using the IPP (B22), and returns the obtained capability information to the auxiliary program 42. The auxiliary program 42 caches, that is, stores in the memory 12, at least a part of the obtained capability information (B23).

Further, the capability information obtained from the printer 3 also includes information necessary for the printer information. For example, when the model name of the printer can be obtained as the capability information, the auxiliary program 42 obtains the model name of the printer from the capability information.

The printer information necessary for caching also includes specific information that cannot be obtained by the IPP. For example, the serial number may not be obtained by the IPP. Therefore, the auxiliary program 42 obtains the specific information that cannot be obtained by the IPP from the printer 3 by a communication method different from the IPP (B24). In B24, the communication with the printer 3 is performed without using the universal printing program 41. Examples of the communication method different from the IPP include MIB (abbreviation for Management Information Base). Further, the communication may be performed via a USB port. The IPP is an example of a first communication method. The MIB is an example of a second communication method.

In a case where all the printer information necessary for caching can be obtained using the IPP in B21, B24 may be omitted. Further, instead of obtaining the printer information by using the IPP in B21, the printer information may be obtained by a communication method different from the IPP in B24.

The auxiliary program 42 generates the printer information to be cached, based on the capability information obtained in B21 or the specific information obtained in B24 (B25). The processing from B21 to B25 is an example of obtaining processing. The printer information is an example of device information. Then, the auxiliary program 42 caches, that is, stores the generated printer information in the memory 12 (B26).

The auxiliary program 42 transfers the capability information read in B11 or the capability information cached in B23 to the universal printing program 41 (B05). The universal printing program 41 transfers, to the editing application 43, the capability information transferred from the auxiliary program 42 (B06). Thus, the display contents of the print setting screen 50 are updated based on the capability information.

### Procedure when Detailed Setting Button is Operated

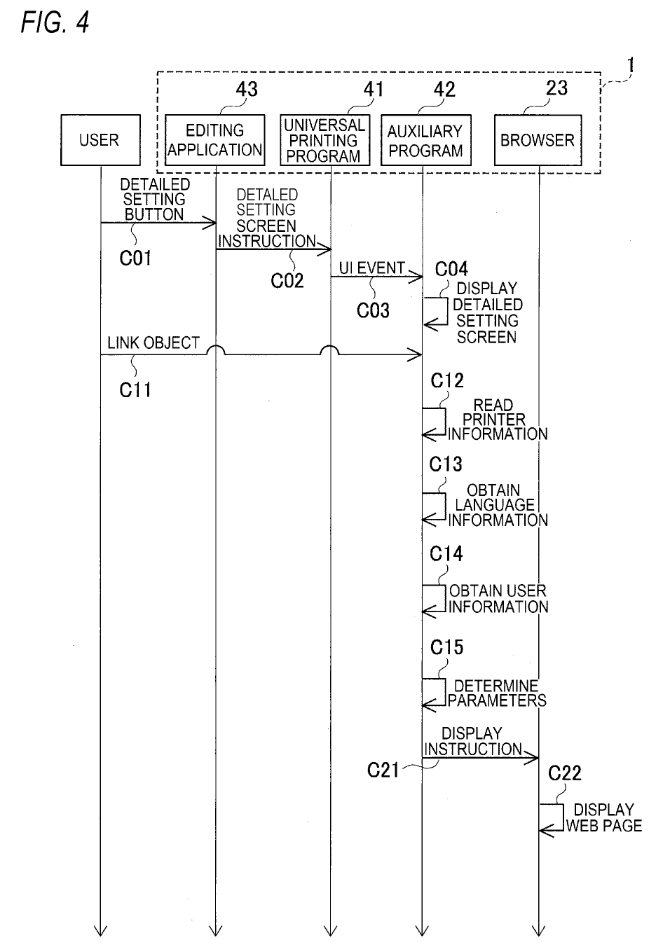

Next, a procedure when the auxiliary program 42 displays a detailed setting screen will be described with reference to a sequence diagram of FIG. 4.

When receiving an operation on the detailed setting button 54 of the print setting screen 50 (C01), the editing application 43 instructs the universal printing program 41 to display the detailed setting screen (C02). Then, the universal printing program 41 issues a UI event for displaying the detailed setting screen (C03). The UI event is an example of a predetermined execution instruction and is also an example of a setting screen display instruction.

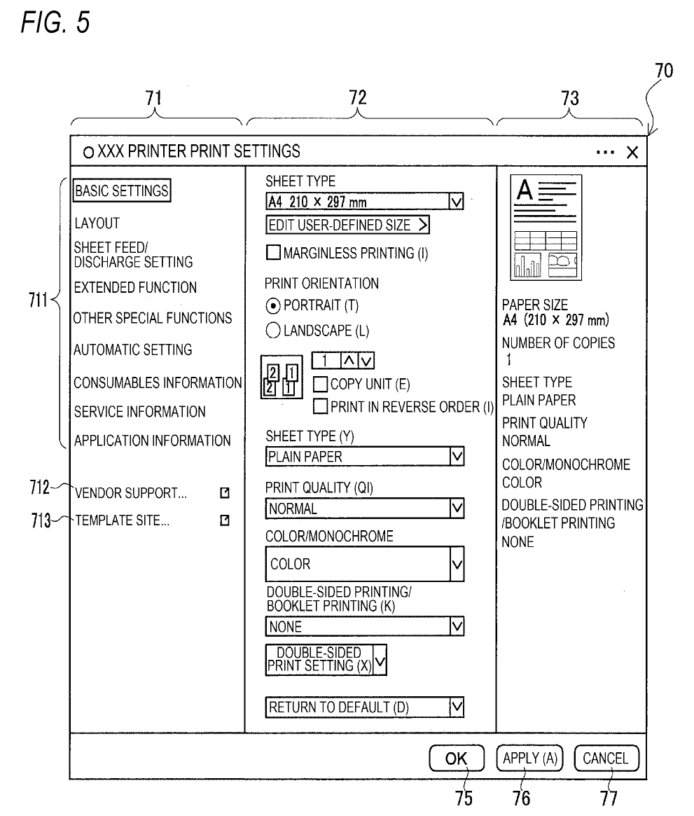

When the UI event is issued, the auxiliary program 42 displays, on the user IF 13, a detailed setting screen 70 as shown in FIG. 5 (C04). C04 is an example of screen display processing. Based on the capability information of the selected printer, the auxiliary program 42 determines setting items and selectable parameters to be received via the detailed setting screen 70. The user determines the print settings via the detailed setting screen 70.

The detailed setting screen 70 of the present embodiment includes multiple pages, and displays a selected page. A display region of the detailed setting screen 70 is divided into a selection region 71 for selecting a page to be displayed, a page display region 72 for displaying contents of the selected page, and a setting content display region 73 indicating currently set print settings. The detailed setting screen 70 includes an OK button 75, an apply button 76, and a cancel button 77.

A tab field 711 for receiving selection of a page is disposed in the selection region 71. The detailed setting screen 70 shown in FIG. 5 shows a state in which a basic setting tab is selected in the tab field 711, and a page corresponding to the basic setting tab is displayed in the page display region 72. The page corresponding to the basic setting tab is a page for receiving settings of basic items in the print settings. A page corresponding to a layout setting tab is a page for receiving settings related to a layout of an image. A page corresponding to a sheet feed/sheet discharge setting tab is a page for receiving settings related to sheet feed or sheet discharge. A page corresponding to a consumables information tab is a page for displaying information related to consumables used in the selected printer. A page corresponding to a service information tab is a page for displaying information related to a service available to the selected printer. A page corresponding to an application information tab is a page for displaying information on the auxiliary program 42.

The setting items in the print settings differ depending on a type of the selected printer. Therefore, the auxiliary program 42 receives detailed print settings related to printing of the selected printer via the detailed setting screen 70 according to the type of the selected printer. For example, it is assumed that the printer 3 is a large printer capable of performing post-processing such as stapling. In this case, the detailed setting screen 70 includes a setting item for the post-processing. Further, it is assumed that the printer 3 is a label printer capable of performing printing on a roll sheet. In this case, a roll sheet can be selected as a sheet type via the detailed setting screen 70.

In the setting content display region 73, all or a part of the print setting items may be displayed. When the apply button 76 is operated after setting values of the items displayed in the page display region 72 are changed by a user operation, the auxiliary program 42 updates the setting content display region 73.

In addition to the tab field 711, a first link object 712 and a second link object 713 each for guiding to a predetermined web page are disposed in the selection region 71. The first link object 712 is an object for guiding to a product information site for the printer 3. On the product information site, for example, a manual and defect information of the printer 3 are published. The second link object 713 is an object for guiding to a download site for a template. On the download site, a printable template is published for each printer model, and the template can also be downloaded. In addition, various objects each for guiding to a predetermined web page may be disposed in the selection region 71. The first link object 712 and the second link object 713 are examples of a guide object. The first link object 712 and the second link object 713 are also examples of operators for displaying a specific web page. Further, the processing (C04) of displaying the detailed setting screen 70 including the first link object 712 and the second link object 713 is an example of guide display processing.

Thereafter, the user operates the first link object 712 or the second link object 713 (C11). In response to the operation, the auxiliary program 42 reads the cached printer information (C12). The auxiliary program 42 obtains the model name and the serial number from the read printer information. When the printer information is not cached or the cached file is broken, the auxiliary program 42 may obtain the printer information from the printer 3 in C12. Specifically, the processing of B21 to B26 in FIG. 3 may be executed in C12. In this case, C12 is an example of the obtaining processing.

Further, the auxiliary program 42 obtains language information from the OS 21 (C13). In a case where the printer information includes language information set for the printer, the language information may be obtained from the printer information instead of the OS 21. C13 is an example of language obtaining processing.

Further, the auxiliary program 42 obtains user information (C14). Examples of the user information include UUID and GUID. The auxiliary program 42 obtains user information registered in the OS 21, for example. The auxiliary program 42 may not be able to access the user information registered in the OS 21, and cannot obtain the user information. In this case, the auxiliary program 42 may obtain the user information via the intermediate application 49 (see FIG. 1), for example. C14 is an example of user obtaining processing. When the auxiliary program 42 can directly obtain the user information registered in the OS 21, the intermediate application 49 is unnecessary.

The auxiliary program 42 that obtains the printer information, the language information, and the user information determines parameters (C15). For example, the vendor of the printer 3 provides a web page indicating product information of the printer for each model. Therefore, the auxiliary program 42 determines the parameters based on the printer information such that the web page suitable for the selected model can be accessed. Further, the vendor of the printer 3 provides a web page for each language by the web server 9. Therefore, the auxiliary program 42 determines the parameters based on the language information such that the web page displayed in a language suitable for the user can be accessed.

Further, the auxiliary program 42 determines the parameters such that the serial number and the model information included in the printer information can be provided to the web server 9. By determining the parameters including the serial number of the printer, for example, the web server 9 can track each serial number. A procedure for determining the parameters including the serial number of the printer is an example of first generation processing. Further, the auxiliary program 42 determines the parameters such that the user information can be provided to the web server 9. By determining the parameters including the user information, for example, the web server 9 can track each user. The vendor of the printer 3 can use the information tracked by the web server 9 for product development. A procedure for determining the parameters including the user information is an example of second generation processing.

The auxiliary program 42 activates the browser 23 and instructs the browser 23 to display a web page based on a URL including the determined parameters as query parameters (C21). For example, the auxiliary program 42 transfers a URL including the determined parameters in address information indicating a position of the product information site to the browser 23. The browser 23 accesses the web server 9 based on the URL transferred from the auxiliary program 42. Then, a web page provided by the web server 9 as an access destination is displayed on the user IF 13 (C22). For example, when the first link object 712 is operated, a URL of the web server 9 of the vendor of the printer 3 is transferred to the browser 23. Therefore, the product information site provided by the vendor of the printer 3 is displayed by the browser 23. When the second link object 713 is operated, a URL of the web server 9 of a company that provides services using the printer 3 is transferred to the browser 23. Therefore, a download site for a template provided by the company is displayed by the browser 23. The URL includes a parameter corresponding to the model name of the printer, and a web page suitable for the selected printer is displayed. Further, the URL includes a parameter corresponding to the language information, and a web page suitable for a language of the user is displayed. Without being limited to a method using the query, the auxiliary program 42 may transfer a URL including at least a part of the determined parameters as address information to the browser 23. For example, the web server 9 may prepare the address information indicating the position of the product information site for each model of the printer, and the auxiliary program 42 may transfer the URL including the address information indicating the position of the product information site corresponding to the model to the browser 23.

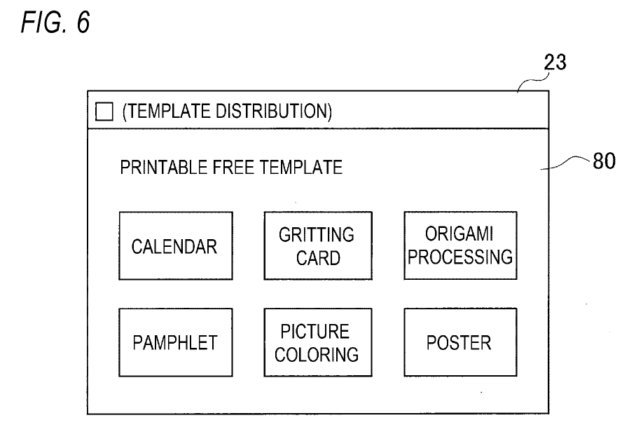

FIG. 6 shows a web page 80 displayed by the browser 23 when the second link object 713 is operated. FIG. 6 further shows web page 80 in a case where the printer 3 is a cut sheet-compatible model and a language of the OS 21 is Japanese. In this case, the web page 80 is a Japanese web page for receiving a download of a template for the cut sheet. If the language of the OS 21 is English, the browser 23 displays an English web page. If the printer 3 is a model of a label printer, a web page from which a template of a label can be downloaded is displayed.

In the present embodiment described above, the detailed setting screen 70 includes the first link object 712 and the second link object 713 for guiding to a predetermined web page. The user can browse a predetermined web page suitable for the selected printer by a simple operation of operating the first link object 712 or the second link object 713. That is, the user is guided to a predetermined web page by operating each link object.

### Procedure when Consumables Information Tab is Operated

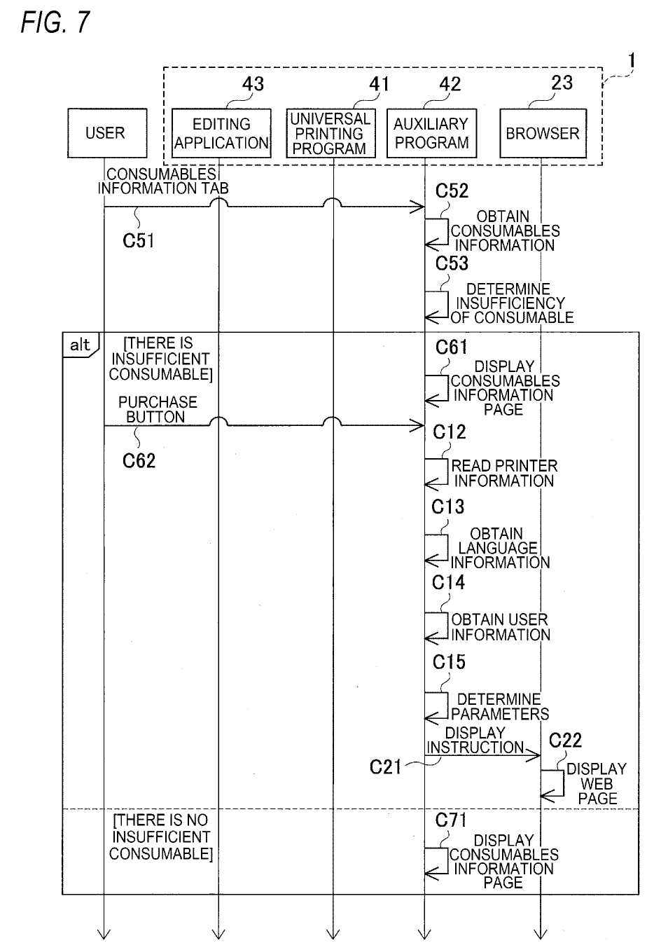

Next, a procedure when the consumables information tab included in the selection region 71 of the detailed setting screen 70 is operated will be described with reference to a sequence diagram of FIG. 7. The same processing as in the sequence diagram shown in FIG. 5 is denoted by the same reference numeral, and description thereof will be omitted.

When receiving an operation on the consumables information tab of the detailed setting screen 70 (C51), the auxiliary program 42 obtains consumables information of the selected printer 3 (C52). C52 is an example of consumables obtaining processing. If the consumables information can be obtained by the IPP, the auxiliary program 42 requests the universal printing program 41 to obtain the consumables information. If the consumables information cannot be obtained by the IPP, the consumables information is directly obtained from the printer by a communication method other than the IPP. For example, in a case of a printer capable of performing color printing, multiple color materials are consumables. The auxiliary program 42 obtains a usage amount or a remaining amount of each of the color materials as the consumables information from the printer capable of performing color printing. In a case of a label printer, a tape is a consumable. The auxiliary program 42 obtains a usage amount or a remaining amount of the tape as the consumables information from the label printer.

The auxiliary program 42 determines whether the consumable is insufficient based on the obtained consumables information (C53). For example, if the printer is a color printer and the consumables information is a remaining amount of each color material, the auxiliary program 42 determines that the remaining amount is insufficient when the remaining amount is smaller than a threshold.

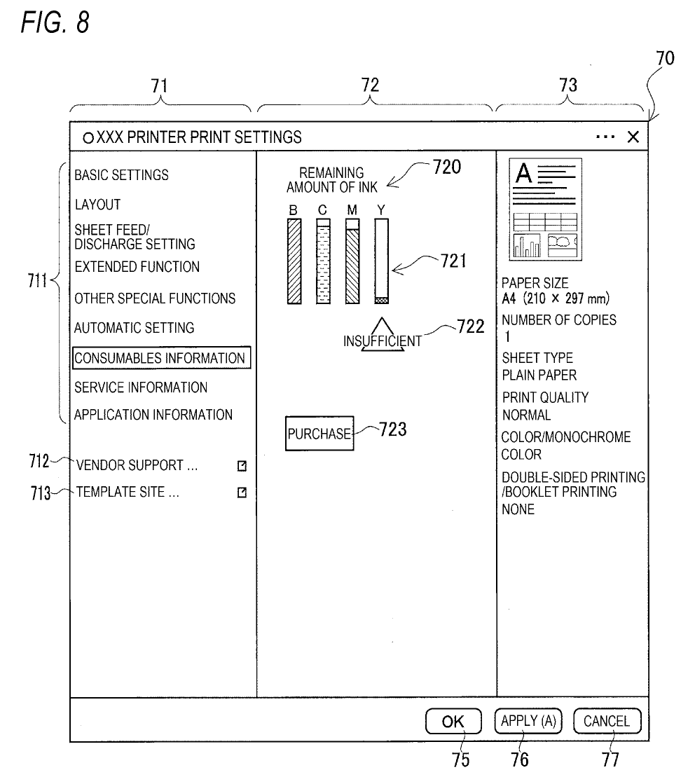

When the consumables are insufficient, the auxiliary program 42 displays a consumables information page for notifying the insufficiency of the consumables in the page display region 72 (C61). FIG. 8 shows an example of a consumables information page 720 for notifying the insufficiency of the consumables. The consumables information page 720 includes a remaining amount diagram 721 indicating a remaining amount of each color material, a notification mark 722 indicating insufficiency in association with an insufficient color material, and a purchase button 723. The remaining amount diagram 721 for each color material enables the user to grasp the remaining amount of each color material. The notification mark 722 enables the user to recognize a color material being insufficient and the insufficient color material. The purchase button 723 is an object for guiding to a purchase site where the consumables can be purchased. The purchase button 723 is an example of the guide object. The purchase button 723 is also an example of the operator for displaying a specific web page. The consumables information page 720 is also a part of the detailed setting screen 70, and can be said to be a screen displayed when an instruction is received from the OS 21. Therefore, the processing (C61) of displaying the consumables information page 720 including the purchase button 723 is an example of the guide display processing. The consumables information page 720 is an example of a first screen. C61 is also an example of first screen display processing.

When the purchase button 723 is operated by the user (C62), the auxiliary program 42 obtains the printer information, the language information, and the user information (C12 to C14). Further, the auxiliary program 42 determines the parameters to be included in the URL (C15).

The auxiliary program 42 activates the browser 23 and instructs the browser 23 to display a web page based on a URL including the determined parameters as query parameters (C21). The browser 23 accesses the purchase site based on the URL transferred from the auxiliary program 42. Then, the web page provided by the purchase site is displayed on the user IF 13 (C22). The URL includes the parameter corresponding to the model name of the printer, and a web page suitable for the selected printer is displayed. Further, the URL includes the parameter corresponding to the language information, and a web page suitable for the language of the user is displayed. Thus, the user easily purchases the consumables of the selected printer.

For example, if the printer is an inkjet printer, the URL includes a parameter corresponding to the inkjet printer. Therefore, when the purchase button 723 is operated, a purchase site for an ink cartridge is displayed. When available cartridges are different for each model, a purchase site for a cartridge compatible with the model is displayed. Meanwhile, if the printer is a label printer, the URL includes a parameter corresponding to the label printer. Therefore, when the purchase button 723 is operated, a purchase site for a tape is displayed. According to the example described above, the inkjet printer is an example of a first model. The purchase site for the ink cartridge is an example of a first page enabling purchase of consumables corresponding to the first model. The label printer is an example of a second model. The purchase site for the tape is an example of a second page enabling purchase of the consumables corresponding to the second model.

On the other hand, if there is no insufficient consumable, the auxiliary program 42 displays, in the page display region 72, a consumables information page that does not notify the insufficiency of the consumables (C71). C71 is an example of the first screen display processing. Specifically, the consumables information page displayed in C71 does not include the notification mark 722 and the purchase button 723 in the consumables information page 720 shown in FIG. 8. When there is a consumable with an insufficient remaining amount, it is highly necessary to view the purchase site for the consumables. Therefore, the auxiliary program 42 performs control to display the purchase site for the consumables, thereby enhancing convenience. On the other hand, if there is no consumable with an insufficient remaining amount, it is not highly necessary to view the purchase site for the consumables. Therefore, the auxiliary program 42 can simplify the display contents of the consumables information page 720 by not performing control to display the purchase site for the consumables. Further, by performing control to display the purchase button 723 only when there is a consumable with an insufficient remaining amount, the user can be suggested to view the purchase site for the consumables.

In the present embodiment, when there is no insufficient consumable, the purchase button 723 is not displayed, but the purchase button 723 may be displayed. By displaying the purchase button 723, the user can view the purchase site at any timing. Therefore, a consumable can be purchased before the consumable is insufficient.

### Procedure when Service Information Tab is Operated

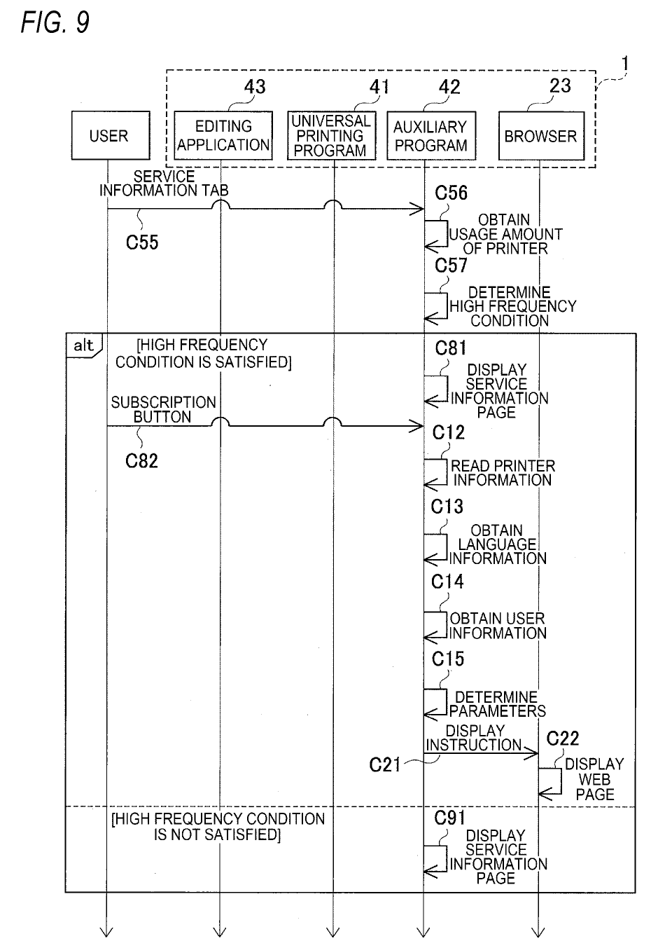

Next, a procedure when the service information tab included in the selection region 71 of the detailed setting screen 70 is operated will be described with reference to a sequence diagram of FIG. 9. The same processing as in the sequence diagram shown in FIG. 5 is denoted by the same reference numeral, and description thereof will be omitted.

When receiving an operation on the service information tab of the detailed setting screen 70 (C55), the auxiliary program 42 obtains usage amount information of the selected printer 3 (C56). C56 is an example of usage amount obtaining processing. The usage amount information of the printer 3 is, for example, information indicating a total number of printed sheets in the printer 3 or the number of printed sheets in a predetermined period. The auxiliary program 42 counts the number of printed sheets for each printing and stores a count result as the usage amount information. The usage amount information may be stored for each user. In C55, the usage amount information can be obtained by reading the stored usage amount information. The usage amount information may be included in the printer 3. In this case, the auxiliary program 42 obtains the usage amount information from the printer 3. Further, the usage amount information may be information indicating the number of printed sheets in each of color printing and monochrome printing. Further, the usage amount information is not limited to the number of printed sheets, and may be the usage amount of each color material.

The auxiliary program 42 determines whether a high frequency condition is satisfied based on the obtained usage amount information (C57). The high frequency condition is a condition indicating that a usage frequency of the printer 3 is high. As the high frequency condition, for example, if the usage amount information is the number of printed sheets, the number of printed sheets being larger than a threshold can be applied. For example, if the usage amount information is the usage amount of the color material, the usage amount of the color material being larger than a threshold can be applied.

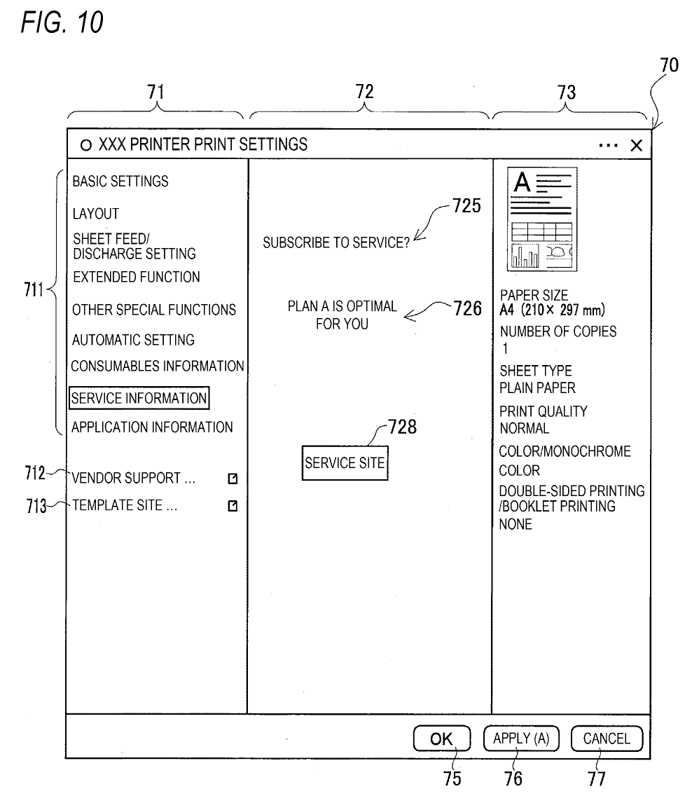

If the high frequency condition is satisfied, the auxiliary program 42 displays, in the page display region 72, a service information page that proposes subscription to a service available to the user of the printer 3 (C81). FIG. 10 shows an example of a service information page 725 that proposes subscription to the service. The service information page 725 includes a proposal message 726 indicating a service subscription proposal and a service site button 728. The proposal message 726 enables the user to grasp that there is a service suitable for the user. The service site button 728 is an object for guiding to a service subscription site that can be subscribed to the service. The service site button 728 is an example of the guide object. The service site button 728 is also an example of the operator for displaying a specific web page. The service information page 725 is also a part of the detailed setting screen 70, and can be said to be a screen displayed when an instruction is received from the OS 21. Therefore, the processing (C81) of displaying the service information page 725 including the service site button 728 is an example of the guide display processing. The service information page 725 is an example of a second screen. C81 is also an example of second screen display processing.

Examples of the service related to the printer include a service of using the printer in a limited period by a subscription method, a service of using the printer in a limited number of printed sheets by a prepaid method, and a service of using various extended functions set to be unselectable at the time of factory shipment. The various services may be paid or free of charge. A type of service applicable to each printer may be different for each printer model.

When the service site button 728 is operated by the user (C82), the auxiliary program 42 obtains the printer information, the language information, and the user information (C12 to C14). Further, the auxiliary program 42 determines the parameters to be included in the URL (C15).

The auxiliary program 42 activates the browser 23 and instructs the browser 23 to display a web page based on a URL including the determined parameters as query parameters (C21). The browser 23 accesses the service subscription site based on the URL transferred from the auxiliary program 42. Then, the web page provided by the service subscription site is displayed on the user IF 13 (C22). The URL includes the parameter corresponding to the model name of the printer, and a web page suitable for the selected printer is displayed. Further, the URL includes a parameter corresponding to the language information, and a web page suitable for the language of the user is displayed. Thus, the user easily considers the subscription to the service of the selected printer.

For example, a suitable service differs depending on whether the printer is used by an individual or used by multiple persons. If the printer is a large printer for companies, the URL includes a parameter corresponding to the large printer. Therefore, when the service site button 728 is operated, a company-dedicated service subscription site is displayed that introduces a plan in which the number of printable sheets within a period is large. If the printer is a small printer for individuals, the URL includes a parameter corresponding to the small printer. Therefore, when the service site button 728 is operated, an individual-dedicated service subscription site is displayed that introduces a plan in which the number of printable sheets within a period is small. A large printer for companies is an example of the first model. The company-dedicated service subscription site is an example of the first page capable of guiding to a service corresponding to the first model. The small printer for individuals is an example of the second model. The individual-dedicated service subscription site is an example of the second page capable of guiding to a service corresponding to the second model.

On the other hand, if the high frequency condition is not satisfied, the auxiliary program 42 only introduces the service and displays a service information page, which does not guide the subscription, in the page display region 72 (C91). C91 is an example of the second screen display processing. Specifically, the service information page displayed in C91 does not include the proposal message 726 and the service site button 728 in the service information page 725 shown in FIG. 10. Further, instead of the proposal message 726, an introduction message for introducing the service is included. When the high frequency condition is satisfied, an advantage for the user to use the service is high. Therefore, by performing control to display the service subscription site, the user can easily subscribe to the service. On the other hand, if the high frequency condition is not satisfied, the advantage for the user to use the service is not high. Therefore, the auxiliary program 42 can simplify the display content of the service information page 725 by not performing control to display the service subscription site. Further, by performing control to display the service site button 728 only when the high frequency condition is satisfied, the user can be suggested to view the service site.

If the user has already subscribed to the service, the service site button 728 may not be displayed even when the high frequency condition is satisfied. Alternatively, if there is a more optimal plan, the service site button 728 may be displayed to update contract contents even when the user has subscribed to the service.

### Procedure during Printing

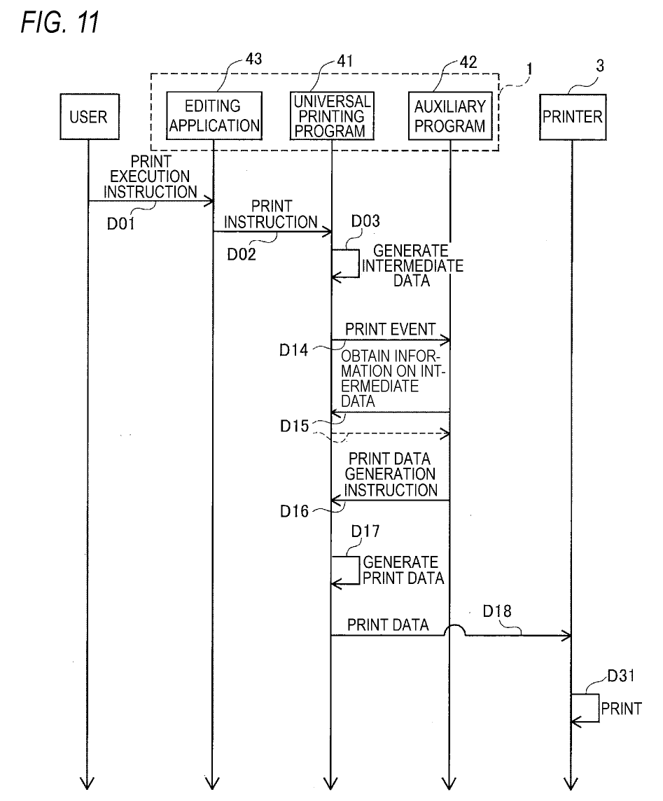

The user can instruct to print by operating the print button 55 on the print setting screen 50 shown in FIG. 2. Specifically, when the printing is instructed by operating the print button 55, a procedure shown in a sequence diagram of FIG. 11 is performed.

The user determines an image as a print target and a printer for performing printing in advance via the editing application 43. In a state where the printer for performing printing is selected, a print execution instruction is input via the editing application 43 (D01). When there is a print execution instruction, the editing application 43 determines that an execution instruction has been received for the universal printing program 41 to cause the selected printer to print the selected image. The editing application 43 outputs information on the received print instruction to the universal printing program 41 (D02).

The universal printing program 41 obtains, as the information on the print instruction, at least information indicating image data indicating an image serving as the print target from the editing application 43. The universal printing program 41 may obtain information on the print settings. The universal printing program 41 generates the intermediate data based on the information obtained from the editing application 43 (D03). In D03, the intermediate data is generated by converting the image data of the image as the print target into data in a format determined in advance.

The image data obtained from the editing application 43 is of various types. Therefore, the universal printing program 41 converts the image data as the print target into intermediate data suitable for generating the print data. If the image data as the print target is data suitable for generating the print data, the generation of the intermediate data may be omitted. That is, the image data as the print target may be used as the intermediate data as it is. When the image data included in the editing application 43 is not suitable for processing in the universal printing program 41, the universal printing program 41 may skip D03. Alternatively, the image data obtained from the editing application 43 may be used as the intermediate data as it is.

After the intermediate data is generated, the universal printing program 41 issues a print event for causing a printer as a control target to perform printing (D14). When the print event is issued, the auxiliary program 42 obtains information on the intermediate data generated by the universal printing program 41 (D15).

The auxiliary program 42 edits the obtained intermediate data as necessary. Then, the universal printing program 41 is instructed to generate the print data based on the intermediate data and the print settings (D16). The universal printing program 41 generates the print data in a format compatible with the IPP in response to the instruction from the auxiliary program 42 (D17). That is, the auxiliary program 42 transfers the intermediate data to the universal printing program 41 and causes the universal printing program 41 to generate the print data. If the auxiliary program 42 can generate the print data in a format compatible with the IPP, the auxiliary program 42 may generate the print data. Examples of the format compatible with the IPP include PDF and PCL.

Then, a print job including the print data is transmitted from the universal printing program 41 to the printer 3 (D18). The transmission of the print job from the universal printing program 41 is performed by the IPP.

When receiving the print job from the PC 1, the printer 3 performs printing based on the print data included in the received print job (D31). In D31, the auxiliary program 42 transmits a print job suitable for the specified printer 3. Therefore, the specified printer 3 can appropriately perform printing based on the print job.

As described above in detail, the auxiliary program 42 obtains the printer information including the model information of the printer 3 as the control target. Further, when a display instruction of the detailed setting screen 70 is received from the OS 21, an object for guiding to the web page corresponding to the model of the printer as the control target is displayed. For example, the first link object 712, the second link object 713, the purchase button 723, and the service site button 728 are displayed. When these objects are operated, the URL corresponding to the operated object is transferred to the browser 23. Then, the web page specified by the URL is displayed by the browser 23. Thus, based on the guide object, the user can be guided to a web page suitable for the printer as the control target.

The embodiment disclosed in the present description is merely an example, and does not limit the present invention. Therefore, various improvements and modifications can be naturally made to the technique disclosed in the present description without departing from the gist of the present invention. For example, four or more printers may be connected to the PC 1.

Further, for example, the examples of the screens displayed on the user IF 13 are all examples, and are not limited to the shown examples. Further, a wording, a shape, a background, or the like of the object displayed in each screen shown in the drawing may be any type.

In the embodiment, the browser 23 is activated from the auxiliary program 42, and the browser 23 displays a web page. However, if the auxiliary program 42 has a browser function, the auxiliary program 42 itself may display a web page based on a link.

Further, the information used to determine the parameters included in the URL may be only a part of information included in the printer information. The parameters may be determined without using the language information or the user information. When the language information is not included in the parameters of the URL, the web server 9 provides a web page in a language set by default. When the user information is not included in the parameters of the URL, the vendor providing the web server 9 cannot perform tracking, but can provide the web page.

In the embodiment, after the first link object 712 or the second link object 713 is operated, the URL is set, but the URL may be set before the operation. For example, when the detailed setting screen 70 is displayed, C12 to C15 may be executed to set a URL corresponding to each object. In this case, the URL is set before the first link object 712 or the second link object 713 is operated, and the URL of the web page is associated with the first link object 712 or the second link object 713. Therefore, when the object is operated, the processing of C12 to C15 is omitted. The same also applies to the purchase button 723 and the service site button 728. That is, when the consumables information page 720 or the service information page 725 is displayed, C12 to C15 may be executed to set a link corresponding to each button.

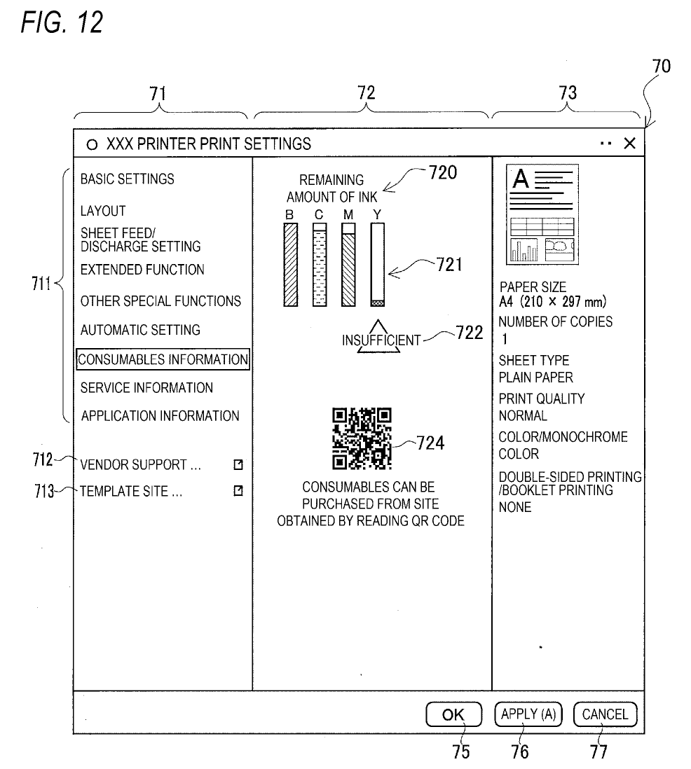

Further, in the embodiment, a two-dimensional code may be displayed instead of displaying the object to which a link is set. For example, as shown in FIG. 12, a QR code (registered trademark) 724 may be displayed on the consumables information page 720 instead of the purchase button 723. Information on the set URL is stored in the QR code 724. The user can cause his or her mobile terminal to display the purchase site indicated by the QR code 724 by reading the QR code 724 with the mobile terminal. The QR code 724 is an example of the guide object. The processing of displaying the detailed setting screen 70 including the QR code 724 is an example of the guide display processing.

The screen including an object for guiding to a predetermined web page is not limited to the detailed setting screen 70. For example, a home screen of the auxiliary program 42 may include an object for guiding to a predetermined web page. Alternatively, for example, a dedicated screen for displaying a state of the consumables may be provided separately from the detailed setting screen 70. For example, when insufficiency of the consumables is detected, a message screen for warning the insufficiency of the consumables corresponds to the dedicated screen. In this case, the dedicated screen may be provided with an object for guiding to the purchase site for the consumables.

Further, the consumables information page 720 and the service information page 725 may be automatically displayed at the time of performing printing without operating the consumables information tab or the service information tab. For example, when there is a print event in D14 of FIG. 11, the processing of C52 to C71 in FIG. 7 and the processing of C56 to C91 in FIG. 9 may be executed based on the consumables information and the usage amount information before performing printing. Further, after D18 of FIG. 11, the processing of C52 to C71 in FIG. 7 and the processing of C56 to C91 in FIG. 9 may be executed based on the consumables information and the usage amount information after performing printing.

In the embodiment, only the printing-related operations have been described in detail as the operations of the auxiliary program 42, but the auxiliary program 42 may also have other roles. Further, a program for executing the processing of the present embodiment is not limited to the auxiliary program 42. That is, a program that receives an instruction from the OS 21 or the universal printing program 41 may be used when printing is performed using the universal printing program 41. For example, a print workflow application whose specifications have been published by Microsoft Corporation may be used.

Further, an execution timing of the auxiliary program 42 is not limited to an example of the embodiment. For example, the execution may be instructed directly from the OS 21. Alternatively, the auxiliary program 42 may be a resident program. In a case of the resident program, the auxiliary program 42 may receive an execution command and perform the above-described operations.

In any flowchart or sequence diagram in the embodiment, an execution order of multiple types of processing in any multiple steps can be freely changed within a range in which no contradiction occurs in processing content. Alternatively, the processing can be executed in parallel.

The processing disclosed in the embodiment may be executed by hardware such as a single CPU, multiple CPUs, or an ASIC, or a combination thereof. Further, the processing disclosed in the embodiment can be implemented in a recording medium in which a program for executing the processing is recorded. Alternatively, the processing can be implemented in various forms such as a method.

The support program described above obtains model information of a printer as a control target. Further, when a predetermined execution instruction is received from an OS, a guide object for guiding to a web page corresponding to a model of the printer as the control target is displayed. Thus, based on the guide object, a user can be guided to a web page suitable for the printer as the control target.

A control method, a computer program, and a computer-readable storage medium storing the computer program, which are for implementing functions of the above device, also have novelty and utility.

According to the technique disclosed in the present description, a technique capable of guiding the user to the specific web page by causing the OS-standard printing function and the support program to cooperate is provided.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A non-transitory computer readable storage medium storing a support program which being executable by a computer of an information processing device and operates in cooperation with a universal printing program provided in an operating system of the information processing device,
the support program
causing the computer to execute obtaining processing of obtaining device information including model information indicating a model of a printer associated with the support program; and
further causing the computer to execute guide display processing of displaying a guide object for guiding to a specific web page corresponding to the model indicated by the model information included in the device information obtained in the obtaining processing, when a predetermined execution instruction is received from the operating system in a state where the printer associated with the support program is selected.

2. The storage medium according to claim 1, wherein
when a setting screen display instruction for instructing display of a print setting screen for receiving print settings is received from the operating system as the predetermined execution instruction, the computer executes screen display processing of displaying the print setting screen on a user interface of the information processing device, and
in the guide display processing executed when the setting screen display instruction is received, the print setting screen includes, as the guide object, an operator for displaying the specific web page, and the specific web page is displayed on the user interface of the information processing device in response to operating the operator.

3. The storage medium according to claim 1, wherein
when a setting screen display instruction for instructing display of a print setting screen for receiving print settings is received from the operating system as the predetermined execution instruction, the computer executes screen display processing of displaying the print setting screen on a user interface of the information processing device, and
in the guide display processing executed when the setting screen display instruction is received, the print setting screen includes, as the guide object, a two-dimensional code storing a URL of the specific web page.

4. The storage medium according to claim 1, the support program further causing the computer to execute
consumables obtaining processing of obtaining consumables information indicating a usage amount of a consumable of the printer associated with the support program; and
first screen display processing of displaying, on a user interface of the information processing device, a first screen including information based on the usage amount of the consumable indicated by the consumables information obtained in the consumables obtaining processing, wherein
in the guide display processing,
when the model information included in the device information obtained in the obtaining processing indicates a first model, control is performed such that the guide object associated with a URL of a first page enabling purchase of a consumable corresponding to the first model is included in the first screen, and
when the model information included in the device information obtained in the obtaining processing indicates a second model, control is performed such that the guide object associated with a URL of a second page enabling purchase of a consumable corresponding to the second model is included in the first screen.

5. The storage medium according to claim 4, wherein
the computer executes the guide display processing when a remaining amount insufficiency condition indicating insufficiency of a remaining amount of the consumable is satisfied based on the usage amount of the consumable indicated by the consumables information obtained in the consumables obtaining processing, and
the computer does not execute the guide display processing when the remaining amount insufficiency condition is not satisfied based on the usage amount of the consumable indicated by the consumables information obtained in the consumables obtaining processing.

6. The storage medium according to claim 1, the support program further causing the computer to execute:
usage amount obtaining processing of obtaining usage information indicating a usage amount of the printer associated with the support program; and
second screen display processing of displaying, on a user interface of the information processing device, a second screen including information based on the usage amount indicated by the usage information obtained in the usage amount obtaining processing, wherein
in the guide display processing,
when the model information included in the device information obtained in the obtaining processing indicates a first model, control is performed such that the guide object associated with a URL of a first page capable of guiding to a service corresponding to the first model is included in the second screen, and
when the model information included in the device information obtained in the obtaining processing indicates a second model, control is performed such that the guide object associated with a URL of a second page capable of guiding to a service corresponding to the second model is included in the second screen.

7. The storage medium according to claim 6, wherein
the computer executes the guide display processing when a high frequency condition indicating that a use frequency of the printer is high is satisfied based on the usage amount indicated by the usage information obtained in the usage amount obtaining processing, and
the computer does not execute the guide display processing when the high frequency condition is not satisfied based on the usage amount indicated by the usage information obtained in the usage amount obtaining processing.

8. The storage medium according to claim 1, wherein
in the obtaining processing,
information capable of being obtained by a first communication method compatible with the universal printing program, among information included in the device information is obtained by the first communication method using the universal printing program, and
information not capable of being obtained by the first communication method, among the information included in the device information is obtained by a second communication method different from the first communication method without using the universal printing program.

9. The storage medium according to claim 1, the support program further causing the computer to execute
language obtaining processing of obtaining, from the operating system, language information indicating a language set in the operating system, wherein
in the guide display processing,
the guide object for guiding to the specific web page corresponding to the model information included in the device information obtained in the obtaining processing and to the specific web page corresponding to the language indicated in the language information obtained in the language obtaining processing is displayed.

10. The storage medium according to claim 1, wherein
in the obtaining processing,
the device information including the model information and a serial number stored in the printer associated with the support program is obtained, and
the support program further causes the computer to execute
first generation processing of generating information indicating a URL of the specific web page corresponding to the model information included in the device information obtained in the obtaining processing, the information including the serial number included in the device information obtained in the obtaining processing.

11. The storage medium according to claim 1, the support program further causing the computer to execute
user obtaining processing of obtaining user information for identifying a user; and
second generation processing of generating information indicating a URL of the specific web page corresponding to the model information included in the device information obtained in the obtaining processing, the information including the user information obtained in the user obtaining processing.
